(19) United States
(12) Patent Application Publication
(10) Pub. No.: US 2008/0267285 A1
(43) Pub. Date: Oct. 30, 2008

(54) PROCESSING MODULE, CONTROL METHOD, AND ELECTRONIC SYSTEM UTILIZING THE SAME

(75) Inventor: Yuan-Chung Lee, Tainan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/741,913

(22) Filed: Apr. 30, 2007

(51) Int. Cl. H04B 1/66

(52) U.S. Cl. 375/240.02

(57) ABSTRACT

A processing module for an electronic system is disclosed. The processing module processes a video signal, provides the processed video signal to a display panel, and includes a decoder and a control unit. The decoder decodes the video signal to generate a decoded data stream. The control unit determines whether to transform the decoded data stream into a transform signal according to a control signal.

### BACKGROUND OF THE INVENTION

1. Field of the Invention

The invention relates to a processing module, and more particularly to a processing module for processing a video signal.

2. Description of the Related Art

With the development technology, the cost of electronic products, such as mobile phones, personal digital assistants (PDAs), and digital still cameras (DSCs), has been substantially reduced while the number of types, designs, and functions of mobile electronic products have increased.

A mobile phone is provided as an example of an electronic product. First generation (1G) mobile phones transmit analog video signals. Second generation (2G) mobile phones transmit digital video signals. Third generation (3G) mobile phones transmit digital video signals and multimedia video signals.

A 3G mobile phone or a portable media player may be utilized to receive a television (TV) signal for immediate viewing. Subsequent to receiving the TV signal a conventional 3G mobile phone or a portable media player executes complex TV signal at the expense of excessive power consumption.

### BRIEF SUMMARY OF THE INVENTION

Processing modules are provided. An exemplary embodiment of a processing module in an electronic system processes a video signal, provides the processed video signal to a display panel, and comprises a decoder and a control unit. The decoder decodes the video signal to generate a decoded data stream. The control unit determines whether to transform the decoded data stream into a transform signal according to a control signal.

A control method is provided. An exemplary embodiment of a control method for driving a display panel of an electronic system is described in the following. A video signal is decoded to generate a decoded signal. The decoded signal is transformed into a transform signal according to a control signal. The decoded signal is provided to drive the display panel if the decoded signal is not transformed into the transform signal. The transform signal is provided to drive the display panel if the decoded signal is transformed into the transform signal.

Electronic systems are also provided. An exemplary embodiment of an electronic system comprises a decoder and a control unit. The decoder decodes a video signal to generate a decoded data stream. The control unit determines whether to process the decoded data stream according to a control signal. The control unit executes one or more operations for the decoded data stream to generating a transform signal.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an electronic system;

FIG. 2 is a schematic diagram of an exemplary embodiment of a processing module;

FIG. 3a is a schematic diagram of an exemplary embodiment of a control unit;

FIG. 3b is a chart showing the scan-rate converter relative to the power status of battery;

FIG. 4 is a schematic diagram of another exemplary embodiment of the processing module; and

FIG. 5 is a schematic diagram of another exemplary embodiment of the control unit.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

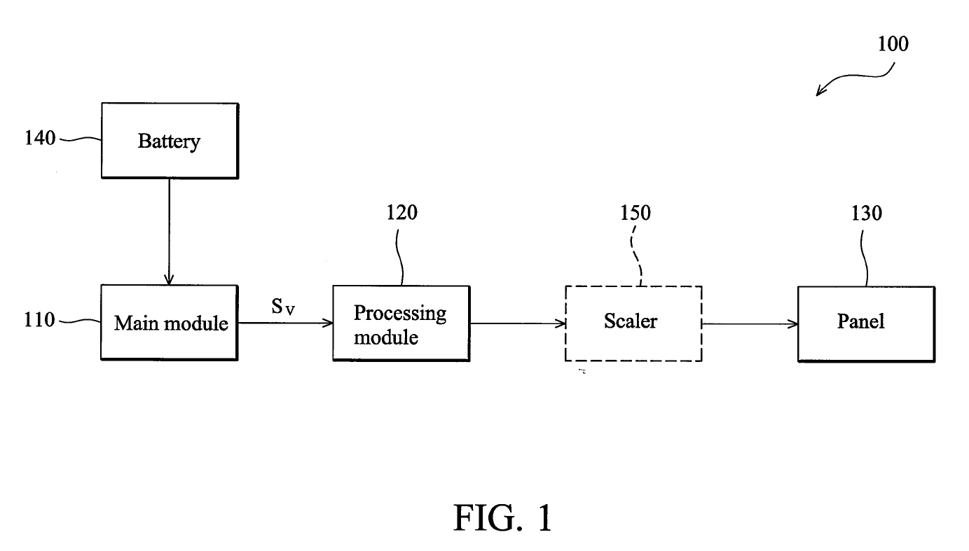

FIG. 1 is a schematic diagram of an exemplary embodiment of an electronic system. Electronic system 100 comprises a main module 110, a processing module 120, a panel 130, and a battery 140. Main module 110 receives power battery 140 and executes functions relating to electronic system 100. Processing module 120 is coupled between main module 110 and panel 130. Processing module 120 drives panel 130 to display a corresponding image according to a video signal S_{V} output from main module 110.

If electronic system 100 is a mobile phone, main module 110 executes communication functions. If electronic system 100 is a PDA or a portable media player, main module 110 executes data processing functions.

Main module 110 receives a video signal S_{V} from an antenna (not shown) and transmits the video signal S_{V} to processing module 120. Processing module 120 drives panel 130 to display corresponding images according to the video signal S_{V}. In this embodiment, the video signal S_{V} received by main module 110 is a TV signal. Additionally, a scaler 150 is coupled between processing module 120 and panel 130 for processing a signal output from processing module 120. Scaler 150 could be an up scaler or a down scaler depended on the design requirement.

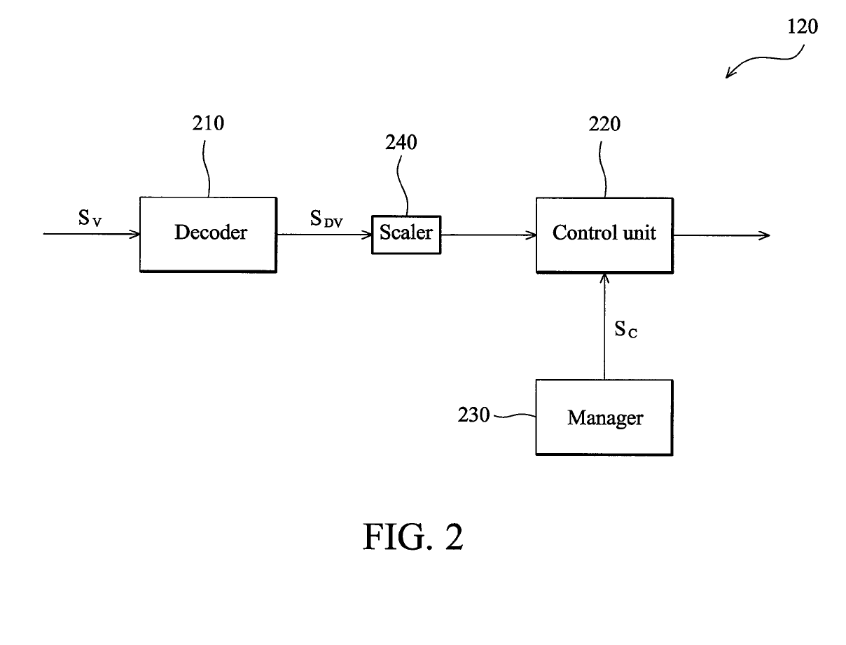

FIG. 2 is a schematic diagram of an exemplary embodiment of a processing module. Processing module 120 comprises a decoder 210, a control unit 220, and a manager 230. Decoder 210 decodes the video signal S_{V} to generate a decoded data stream S_{DV}. Control unit, 220 determines whether to process the decoded data stream S_{DV} according to a control signal S_{C} generated by manager 230. Control unit 220 comprises a plurality of processing function elements and the control signal provide a control message to determine whether to deactivate at least one of said processing function elements.

Manager 230 provides a control signal S_{C} according to a specific state, such as a power state of battery 140 or a temperature state of electronic system 100. In this embodiment, manager 230 is disposed within processing module 120. In some embodiments, manager 230 could be disposed external to processing module 120 as well.

When the power state of battery 140 or the temperature state of electronic system 100 is not within a predetermined range, manager 230 generates and transmits a corresponding control signal S_{C} to control unit 220. Decoded data stream S_{DV} is thus not processed by control unit 220 and is directly output to panel 130. Power consumption is thus reduced.

In some embodiments, processing module 120 further comprises a scaler 240. Scaler 240 is coupled between decoder 210 and control unit 220 for processing the decoded data stream S_{DV}.

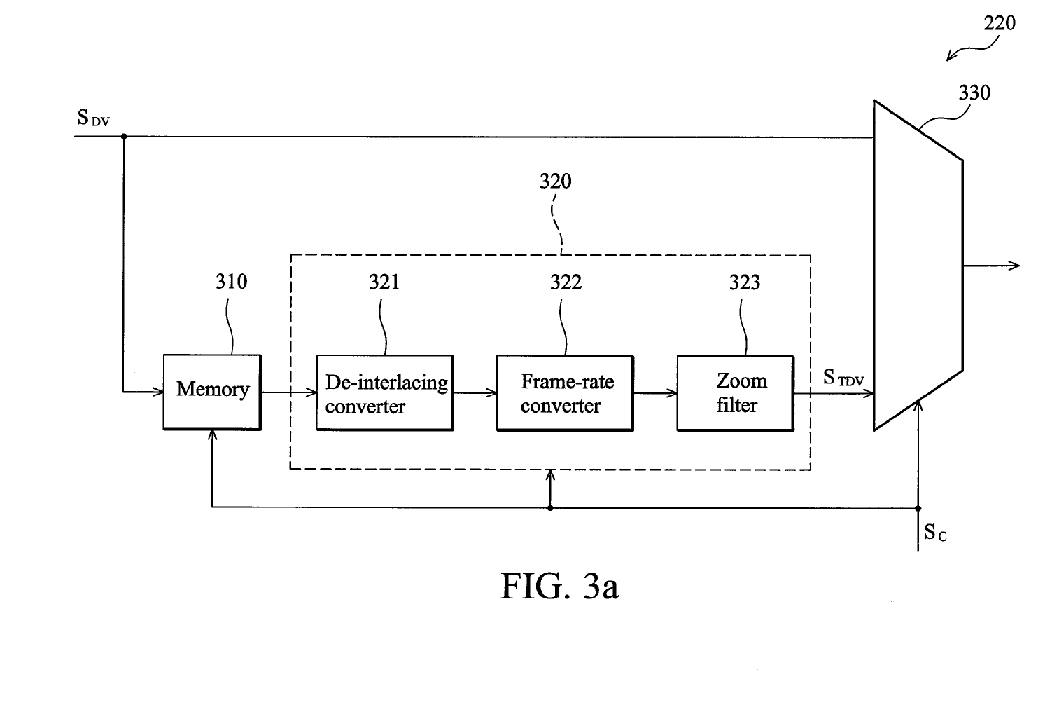

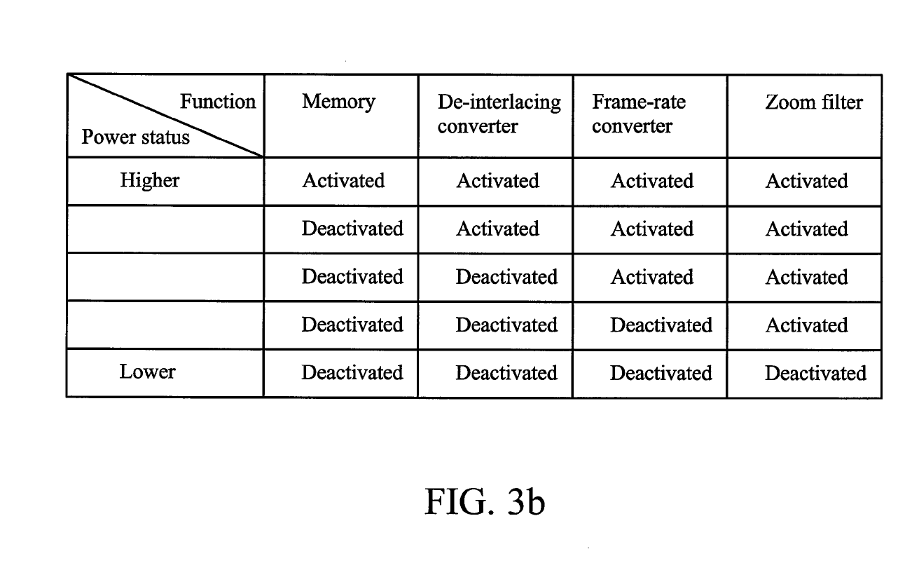

FIG. 3a is a schematic diagram of an exemplary embodiment of a control unit. Control unit 220 comprises a memory 310, a scan-rate converter 320 and a multiplexer 330. Memory 310, such as a DRAM, stores the decoded data stream S_{DV}. Scan-rate converter 320 processes the decoded data stream S_{DV} to generate the transform signal S_{TDV} according to the control signal S_{C}. Multiplexer 330 outputs the decoded data stream S_{DV} or the transform signal S_{TDV} to panel 130 according to the control signal S_{C}.

Scan-rate converter 320 comprises a de-interlacing converter 321, a frame-rate converter 322, and a zoom filter 323. De-interlacing converter 321 performs high-quality de-interlacing of the decoded data stream S_{DV}. Frame-rate converter 322 performs frame-rate conversion of the decoded data stream S_{DV}. Zoom filter 323 performs a zoom-filtering function of the decoded data stream S_{DV}.

FIG. 3b is a chart relating the scan-rate converter to the power status of the battery. When the power state of battery 140 is relatively higher, memory 310, de-interlacing converter 321, frame-rate converter 322, and zoom filter 323 are activated by the control signal S_{C} generated by manager 230, consuming excess power. When the power state of battery 140 is relatively lower, memory 310, de-interlacing converter 321, frame-rate converter 322, and zoom filter 323 are deactivated by the control signal S_{C}, consuming less power. When any processing components are deactivated, the input signal is bypassed to the output for this processing component.

When the power state of battery 140 is between the mentioned higher and lower states, memory 310, de-interlacing converter 321, frame-rate converter 322, and zoom filter 323 are selectively activated/deactivated by the control signal S_{C}. This can be done sequentially or at the same time. In other words, zoom filter 323 might be turned off first, and de-interlacing converter 321 and frame-rate converter 322 might be sequentially deactivated based on the control signal. While the power level gets to relatively low, the memory 310, de-interlacing converter 321, frame-rate converter 322, and zoom filter 323 are all deactivated to save power. In some other cases, two or more processing components might be turned off at the same time. Thus, the decoded data stream S_{DV} is bypassed those control processing units (memory 310, de-interlacing converter 321, frame-rate converter 322, and zoom filter 323). When fewer elements are active, less power is consumed.

In the exemplary embodiment, if the video signal S_{V} output from main module 110 is an analog TV signal, all elements comprising memory 310, de-interlacing converter 321, frame-rate converter 322, and zoom filter 323 can be deactivated by following the method mentioned above. If the video signal S_{V} is a digital TV signal, all elements can be deactivated except memory 310.

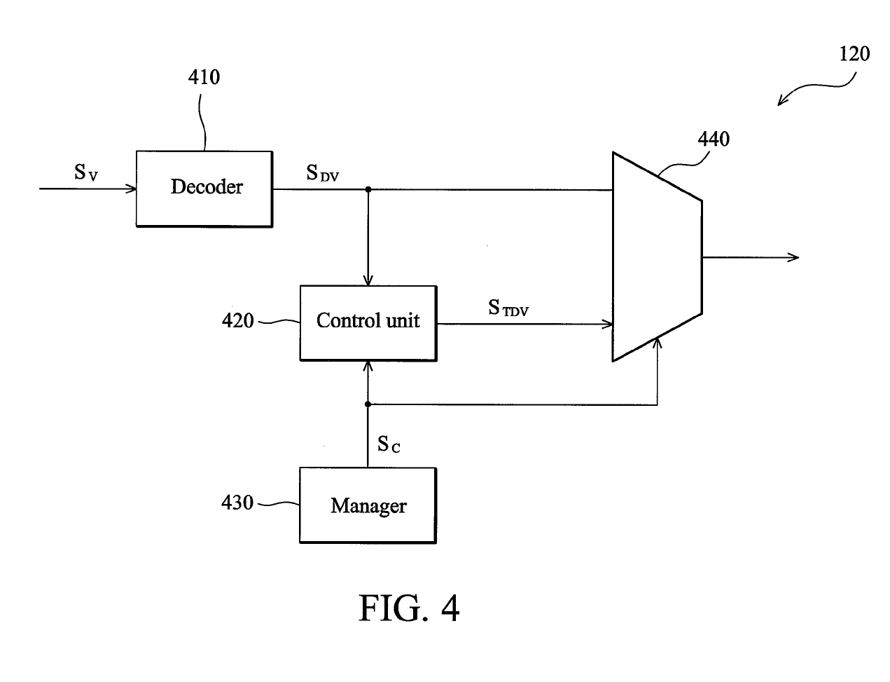

In some embodiments, a multiplexer disposed external to a control unit is utilized, as shown in FIG. 4. FIG. 4 is a schematic diagram of another exemplary embodiment of the processing module. Multiplexer 440 outputs the decoded data stream S_{DV} or the transform signal S_{TDV} to panel 130 according to the control signal S_{C}. Because the operations of decoders 410 and 210 are the same and the operations of managers 430 and 230 are the same, descriptions of decoder 410 and manager 430 are omitted for brevity.

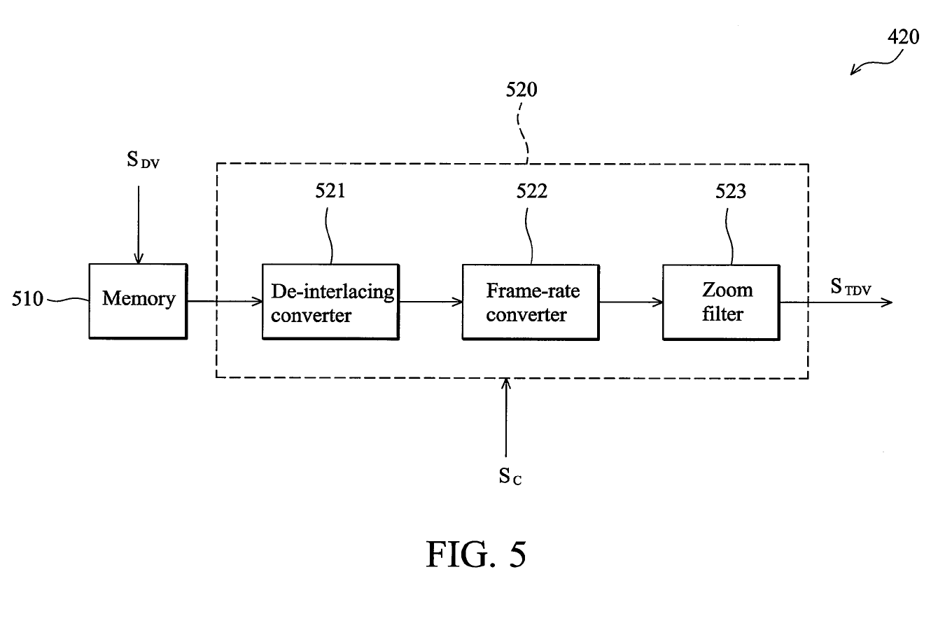

FIG. 5 is a schematic diagram of another exemplary embodiment of the control unit. Control unit 420 comprises a memory 510 and a scan-rate converter 520. Because the operations of memories 510 and 310 are the same and the operations of scan-rate converters 520 and 320 are the same, descriptions of memory 510 and scan-rate converter 520 are omitted for brevity.

Because the information provided in the control signal varies, all elements within the control unit can be selectively deactivated. When the number of deactivated elements is higher, less power is consumed.

A manager or a controller is utilized to generate a control signal according to a specific state. If the control signal generated by the manager or the controller changes according to a power state of a battery, a memory and a scan-rate converter comprising various transformation functions are selectively deactivated or activated. Thus, power consumption is managed to provide optimum efficiency.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A processing module of an electronic system for processing a video signal and providing the processed video signal to a display panel, the processing module comprising:
a decoder decoding the video signal to generate a decoded data stream;
a control unit determining whether to transform the decoded data stream into a transform signal according to a control signal; and
wherein the control unit transforms the decoded signal into a transform signal while the control signal provides a control message to transform the decoded signal.

2. The processing module as claimed in claim 1, further comprising a manager generating a control signal according to a specific state.

3. The processing module as claimed in claim 2, wherein the specific state is determined based on the state of the temperature of the electronic system.

4. The processing module as claimed in claim 2, wherein the specific state is determined based on the power level of the electronic system.

5. The processing module as claimed in claim 2, wherein the control unit does not transform the decoded data stream and directly provides the decoded data stream to drive the display panel if the specific state is not within a desired range.

6. The processing module as claimed in claim 2, further comprising a multiplexer to select one of the signals from the decoded data stream or the transform signal according to the control signal.

7. The processing module as claimed in claim 2, wherein the control unit transforms the decoded data stream into the transform signal when the video signal is a digital TV signal.

8. The processing module as claimed in claim 2, wherein the control unit comprises:
a memory storing the decoded data stream from the decoder; and
a scan-rate converter performing at least one of a frame-rate conversion function, a high-quality de-interlacing function and a zoom-filtering function.

9. The processing module as claimed in claim 8, wherein said memory and said scan-rate converter are bypassed if the manager detects the level of the specific state is not in a desired range.

10. The processing module as claimed in claim 2, further comprising a scaler coupled between the control unit and the display panel for processing the transform signal or the decoded data stream according to the control signal.

11. The processing module as claimed in claim 2, further comprising a scaler coupled between the decoder and the control unit for processing the decoded data stream.

12. A control method for driving a display panel of an electronic system, the control method comprising:
decoding a video signal to generate a decoded signal;
determining whether to transform the decoded signal into a transform signal according to a control signal;
providing the decoded signal to drive the display panel if the decoded signal is not transformed into the transform signal; and
providing the transform signal to drive the display panel if the decoded signal is transformed into the transform signal.

13. The control method as claimed in claim 12, wherein the control signal is based on the power level of the electronic system.

14. The control method as claimed in claim 12, wherein the control signal is based on the state of the temperature of the electronic system.

15. An electronic system for processing video signal comprising:
a decoder decoding a video signal to generate a decoded data stream; and
a control unit determining whether to process the decoded data stream according to a control signal, wherein the control unit comprises a plurality of processing functional elements and the control signal provide a control message to determine whether to deactivate at least one of said processing functional elements.

16. The electronic system as claimed in claim 15, further comprising a manager providing the control signal to the control unit according to a specific state.

17. The electronic system as claimed in claim 16, wherein a plurality of processing functional elements comprising:
a means for de-interlacing;
a means for frame-rate conversion;
a means for zoom filtering;
a means for providing the storage function for the decoded data stream; and
a means for selecting a signal to drive a display panel.

18. The electronic system as claimed in claim 16, wherein the specific state is determined based on the power level of the electronic system.

19. The electronic system as claimed in claim 16, wherein the specific state is determined based on the temperature of the electronic system.

20. The electronic system as claimed in claim 17, wherein at least one of the means is deactivated depending on the specific state.
